(19) United States
(12) Patent Application Publication
(10) Pub. No.: US 2007/0286022 A1
(43) Pub. Date: Dec. 13, 2007

(54) Operating State Management for Seismic Data Acquisition

(75) Inventors: Andrew Bull, Murieston (GB); Dennis R. Pavel, Highland Village, TX (US); Scott T. Hoenmans, Arvada, CO (US); Keith Elder, Richmond, TX (US); Donald E. Clayton, Houston, TX (US); Igor Samoylov, Stafford, TX (US); Richard Eperjesi, Stafford, TX (US)

Correspondence Address: PAUL S MADAN;MADAN, MOSSMAN & SRIRAM, PC, 2603 AUGUSTA DRIVE, SUITE 700, HOUSTON, TX, 77057-5662, US

(73) Assignee: Input/Output, Inc., Houston, TX (US)

(21) Appl. No.: 11/760,410

(22) Filed: Jun. 8, 2007

Related U.S. Application Data
(60) Provisional application No. 60/812,413, filed on Jun. 9, 2006.

(51) Int. Cl. G01V 1/24

(52) U.S. Cl. 367/58

(57) ABSTRACT

A seismic spread has a plurality of seismic stations positioned over a terrain of interest and a controller programmed to automate the data acquisition activity. In one embodiment, the controller forms a queue of sources that are ready to fire and initiating the firing of the sources according to a preset protocol. The sensor stations each include power management circuitry that may shift or adjust the power level of the sensor station during the data acquisition activity. During operation, the controller broadcasts data that the power management circuitry of each sensor station uses to determine the appropriate energy state for that sensor station. This determination may be made using the broadcast data alone or in conjunction with other data such as a GPS-determined position of the sensor station. Thus, in one aspect, each sensor station self-selects an energy state according to the broadcast status of the data acquisition activity. It is emphasized that this abstract is provided to comply with the rules requiring an abstract which will allow a searcher or other reader to quickly ascertain the subject matter of the technical disclosure. It is submitted with the understanding that it will be used to interpret or limit the scope or meaning of the claims. 37 CFR 1.72(b)

### CROSS-REFERENCE TO RELATED APPLICATIONS

This application claims the benefit of and takes priority from U.S. Provisional application 60/812,413 filed on Jun. 9, 2006, which is hereby incorporated herein by reference. This Application is related to U.S. patent application Ser. No. 10/664,566, file on Sep. 17, 2003 title “Single Station Wireless Seismic Data Acquisition Method and Apparatus,” which is hereby incorporated by reference for all purposes.

### BACKGROUND OF THE DISCLOSURE

Oil companies conduct seismic surveying to lower risk and to reduce costs of locating and developing new oil and gas reserves. Seismic surveying is, therefore, an up front cost with intangible return value. Consequently minimizing the cost of seismic surveying and getting quality results in minimum time are important aspects of the seismic surveying process.

Seismic surveys are conducted by deploying a large array of seismic sensors over a terrain of interest. These arrays may cover over 50 square miles and may include 2000 to 5000 seismic sensors. An energy source such as buried dynamite may be discharged within the array to impart a shockwave into the earth. The resulting shock wave is an acoustic wave that propagates through the subsurface structures of the earth. A portion of the wave is reflected at underground discontinuities, such as oil and gas reservoirs. These reflections are then sensed at the surface by the sensor array and recorded as seismic data. Such sensing and recording are referred to herein as seismic data acquisition. This seismic data is then processed to generate a three dimensional map, or seismic image, of the subsurface structures. The map may be used to make decisions about drilling locations, reservoir size and pay zone depth.

Conventional seismic data acquisition systems typically include equipment that have generally static operating modes. That is, for example, devices such as seismic receivers in a seismic spread may be fully operational even during periods when those seismic receivers are not needed to detect seismic data. Such operation can consume resources such as power or data transmission bandwidth and can increase the costs associated with seismic data acquisition. The present disclosure addresses these and other shortcomings of conventional seismic data acquisition systems.

### SUMMARY OF THE DISCLOSURE

In one aspect of the disclosure, a seismic device, such as sensor station, is configured to select an operating state from a number of operating states, each of which correspond with a different level of functionality for that seismic device. An operating state may have an associated power state that may range from a deep sleep state to a full active state or any number of intermediate states. A given operating state may be chosen to optimize power usage for any number of functions or activities, including, but not limited to, status reporting, diagnostics, data collection, pre-processing data, signal/data reception, and data transmission. In one embodiment, a seismic device may be “positionally aware” in that a resident memory includes location data, e.g., latitude and longitude. Thus, the “positionally aware” seismic device can “self-select” an operating state based on its position or location.

In another aspect, a central computer station in communication with the seismic devices may transmit signals that shift the seismic devices between several operating states. In one application involving sensor stations, the central station computer, which may include one or more processors, transmits these signals to the sensor stations while controlling the firing of one or more sources according to preset instructions. An exemplary control methodology may include constructing a list of seismic sources that are ready for firing. One or more in-field mobile units, which may be human operators equipped with suitable tools, locally control the firing of the sources and transmit firing status information to the central station computer. Prior to instructing the firing of the sources in the list or queue, the central station computer broadcasts a data-encoded signal to all or part of the seismic spread. Several methodologies may be employed to utilize the transmitted signal.

In one arrangement, the encoded data may relate to survey data such as the time for an expected shoot, the identity or location of the source to be shot or fired, etc. Upon receiving this signal, the sensor stations process the signal to determine whether or not to transition to a different operating state. For example, if the signal includes an identity of a seismic source, the sensor station may determine whether or not to transition to a different operating state based on the proximity or other relationship of the sensor station to that seismic source; e.g., if the relationship meets a preset criteria, the sensor station self-selects the appropriate operating state such as an operating mode for listening and recording seismic data. Thus, the sensor station, rather than the controller, initiates a transition or selection of the appropriate operating state

In another arrangement, the controller may use the encoded data to instruct selected sensor stations to transition to a desired operating state. For instance, based on the status of the list of seismic sources reporting as ready to fire, the controller may determine that sensors in a given area should be in an operating state for listening and recording data. The signal may be an instruction to transition to that operating state. In one transmission mode, the instruction is sent only to the relevant sensor stations. In another transmission mode, the instructions may be broadcast but include further information that enable each sensor station to determine whether the instructions are to be executed by that sensor station. Exemplary information for making that determination may be position or location coordinates, sensor station identification numbers, time, operating state, etc.

In still another arrangement, the encoded data may include instructions to transition to a one operating state and include further instructions that enable each sensor station to self-select another operating state. For instance, based on the status of the list of seismic sources reporting as ready to fire, the controller may determine that sensors in a given area should be in an operating state to initiate the recording of data. In the same or different signal, data is transmitted to those sensors enable each sensor station to determine whether to actually start recording data. For instance, the controller may determine that several sources are ready to shoot in sequence in a given area and instruct the sensors in that area to move to a ready to record operating state. The same signal or a separate signal may provide information such as timing and/or source position information that enable individual sensors to determine whether to begin recording or wait until a specific source is ready to shoot before moving to a recording state.

In still other aspects, the present disclosure provides for seismic devices a computer-readable medium that is accessible to a processor for executing instructions contained in a computer program embedded on the computer-readable medium. The computer program may include a set of instructions to receive a signal transmitted by a controller positioned in a geographical area of interest; a set of instructions to process the signal to determine an operating state associated with a seismic device configured to measure and record seismic data; and a set of instruction to initiate a transition to the determined operating state. The medium may be associated with one or more sensor stations or any other seismic device. In still another aspect, the present disclosure provides for controllers such as a CSC a computer-readable medium that is accessible to a processor for executing instructions contained in a computer program embedded on the computer-readable medium. The computer program may include a set of instructions to determine an operating state for at least one seismic device positioned in a geographical area of interest; a set of instructions to encode a signal with data relating to the operating state; and a set of instructions to transmit the signal to at least one seismic device positioned in a geographical area of interest.

It should be understood that examples of the more important features of the disclosure have been summarized rather broadly in order that detailed description thereof that follows may be better understood, and in order that the contributions to the art may be appreciated. There are, of course, additional features of the disclosure that will be described hereinafter and will form the subject of the claims appended hereto.

### BRIEF DESCRIPTION OF THE DRAWINGS

The novel features of this disclosure, as well as the disclosure itself, will be best understood from the attached drawings, taken along with the following description, in which similar reference characters refer to similar parts, and in which:

FIG. 1 schematically illustrates a cable seismic data acquisition system;

FIG. 2 schematically illustrates a wireless seismic data acquisition system;

FIG. 3A shows a schematic representation of the system of FIG. 2 in more detail;

FIG. 3B shows one embodiment of a wireless station unit having an integrated seismic sensor;

FIG. 4 is a schematic representation of a wireless station unit incorporating circuitry to interface with an analog output sensor unit;

FIG. 5 is a flow chart representing one exemplary operating state management method according to the present disclosure;

FIG. 6 is a flow chart representing another exemplary operating state management method according to the present disclosure; and

FIG. 7 is a flow chart representing exemplary operating states utilized in connection with the present disclosure.

### DETAILED DESCRIPTION OF THE DISCLOSURE

In aspects, the present disclosure relates to devices and methods for controlling activities relating to seismic data acquisition. The present disclosure is susceptible to embodiments of different forms. There are shown in the drawings, and herein will be described in detail, specific embodiments of the present disclosure with the understanding that the present disclosure is to be considered an exemplification of the principles of the disclosure, and is not intended to limit the disclosure to that illustrated and described herein.

The methods and devices of the present disclosure may be utilized with any type of seismic data acquisition system that utilize in-field and/or centralized control. For context, the equipment and components of two illustrative systems are discussed below.

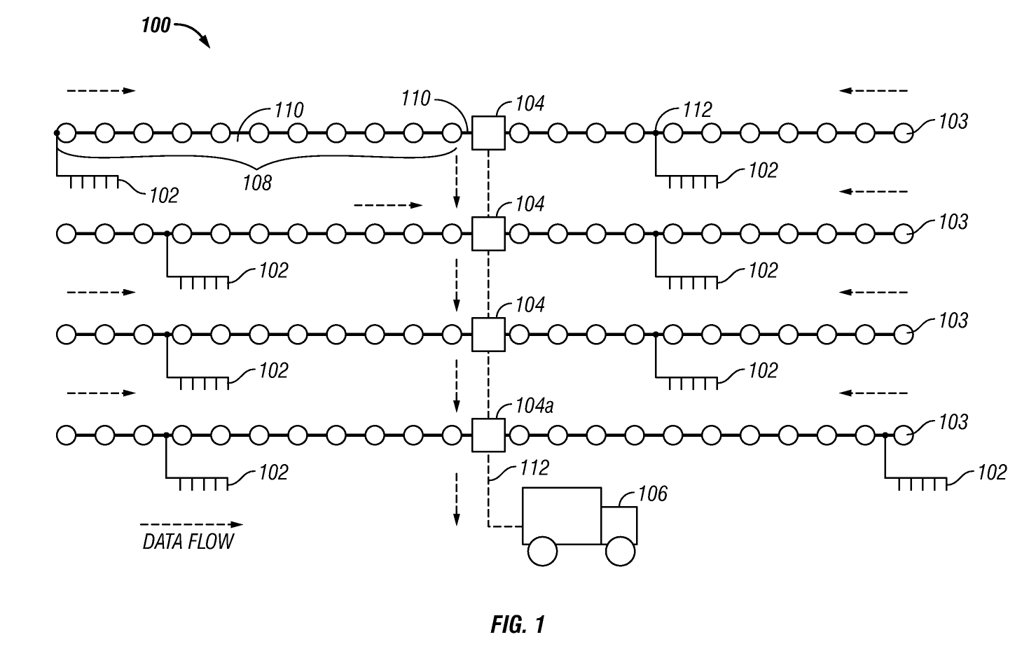

FIG. 1 depicts a typical cable-based seismic data acquisition system 100. The typical system 100 includes an array (string) of spaced-apart seismic sensor units 102. Each string of sensors is typically coupled via cabling to a data acquisition device (field box) 103, and several data acquisition devices and associated string of sensors are coupled via cabling 110 to form a line 108, which is then coupled via cabling 110 to a line tap or (crossline unit) 104. Several crossline units and associated lines are usually coupled together and then to a central controller 106 housing a main recorder (not shown). One sensor unit 102 that is in use today is a velocity geophone used to measure acoustic wave velocity traveling in the earth. Other sensor units 102 that may be used are acceleration sensors (accelerometers) for measuring acceleration associated with the acoustic wave. Each sensor unit may comprise a single sensor element or more than one sensor element for multi-component seismic sensor units.

The sensors 102 are usually spaced at least on the order of tens of meters, e.g., 13.8-220.0 feet. Each of the crossline units 104 may perform some signal processing and then store the processed signals as seismic information for later retrieval. The crossline units 104 are each coupled, either in parallel or in series with one of the units 104a serving as an interface with between the central controller 106 and all crossline units 104.

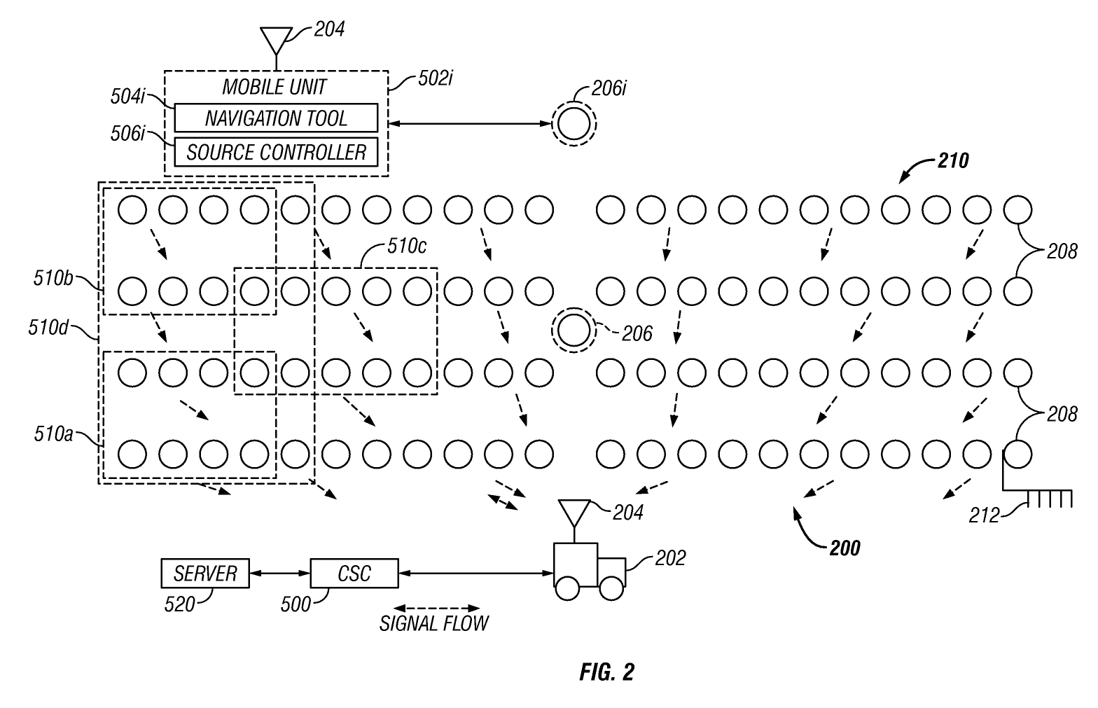

Referring to FIG. 2 there is schematically shown a wireless seismic data acquisition system. The system 200 includes a central controller 202 in direct communication with each of a number of wireless sensor stations 208 forming an array (spread) 210 for seismic data acquisition. Each sensor station 208 includes one or more sensors 212 for sensing seismic energy. Direct communication as used herein refers to individualized data flow as depicted in FIG. 2 by dashed arrows. The data flow may be bi-directional to allow one or more of: transmitting command and control instructions from the central controller 202 to each wireless sensor station 208; exchanging quality control data between the central controller 202 and each wireless sensor station 208; and transmitting status signals, operating conditions and/or selected pre-processed seismic information from each wireless sensor station 208 to the central controller 202. The communication may be in the form of radio signals transmitted and received at the central controller 202 via a suitable antenna 204. The term “seismic devices” includes any device that is used in a seismic spread, including, but not limited to, sensors, sensor stations, receivers, transmitters, power supplies, control units, etc.

The system 200 may operate in a passive mode by sensing natural or random seismic energy traveling in the earth. The system 200 may also operate in an active mode using a seismic energy source 206, e.g., pyrotechnic source, vibrator truck, air gun, compressed gas, etc., to provide seismic energy of a known magnitude and source location. In many applications, multiple seismic energy sources may be utilized to impart seismic energy into a subterranean formation. A representative seismic energy source is designated with numeral 206i. Typically, activation (or more commonly, “shooting” or “firing”) of the source 206i is initiated locally by a mobile unit 502i. In one embodiment, the mobile unit 502i includes a human operator who may utilize a navigation tool 504i to navigate to a source 206i and a source controller 506i to fire the source 206i. To navigate the terrain and to determine precise location coordinates, the navigation tool 504i may be equipped with a global positioning satellite device (GPS device) and/or a database having predetermined coordinates (e.g., z coordinates). It should be understood that a GPS device is merely illustrative of sensors that may be utilized to determine a position or location of a device or point of interest. Other devices may include inertial navigation devices, compasses, the Global Navigational Satellite System (GNSS), or suitable system for obtaining position or location parameters. The navigation tool 504i may also be configured to provide audible or visual signals such as alarms or status indications relating to the firing activity. The source controller 506i may be programmed to receive or transmit information such as instructions to ready the source 206i for firing, instructions to fire the source 206i, data indicative of the location of the mobile unit 502i, the arming status of the source 206i, and data such as return shot attributes. The source controller 506i may also be programmed to fire the source 206i and provide an indication (e.g., visual or auditory) to the human operator as to the arming status of the source 206i. Often, two or more mobile units 502i independently traverse the terrain underlying the spread 210 to locate and fire the sources 206i. In one configuration, the source controller 506i relies on the navigation tool 504i to transmit the location data to the controller 202 or central station computer 500 (described below), either of which transmit the “arm” and “fire” signals to the source controller 506i. These signals are digital signals or suitable analog signals in contrast to the voice signals currently in use. The source controller 506i may include a display to advise the shooter of the status of the firing activity.

The controller 202, the central station computer (CSC) 500 and a central server 520 exert control over the constituent components of the system 200 and direct both human and machine activity during the operation of the system 200. As discussed in greater detail below, the CSC 500 automates the shooting of the sources 206i and transmits data that enables the sensor stations 208 to self-select an appropriate operating state during such activity. The server 520 may be programmed to manage data and activities over the span of the seismic campaign, which may include daily shooting sequences, updating the shots acquired, tracking shooting assets, storing seismic data, pre-processing seismic data and broadcasting corrections. Of course, a single controller may be programmed to handle most if not all of the above described functions. For example, the CSC 500 may be positioned in or integral with the controller 202. Moreover, in some applications it may be advantageous to position the controller 202 and CSC 500 in the field, albeit in different locations, and the server 520 at a remote location.

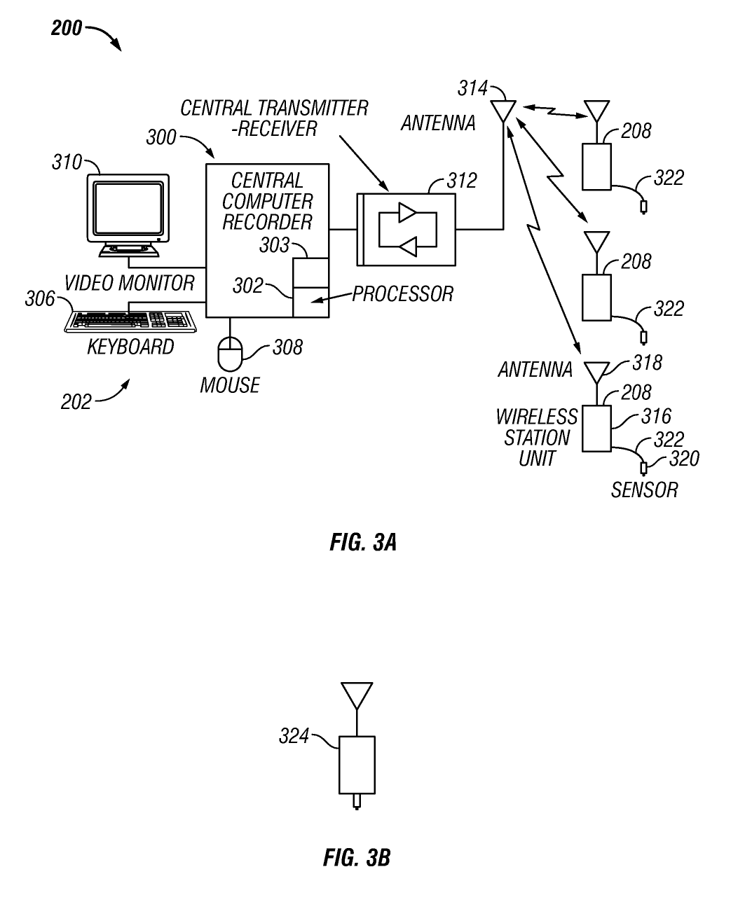

FIG. 3A is a schematic representation of the system 200 in more detail. The central controller 202 includes a computer 300 having a processor 302 and a memory 303. An operator may interface with the system 200 using a keyboard 306 and mouse or other input 308 and an output device such as a monitor 310. Communication between remotely-located system components in the spread 210 and the central controller 202 is accomplished using a central transmitter-receiver (transceiver) unit 312 disposed in the central controller 202 along with an antenna 314.

The central controller 202 may communicate with each wireless sensor station 208 via known RF techniques. Each wireless sensor station 208 includes a wireless station unit 316, an antenna 318 compatible with the antenna 314 used with the central controller 202, and a sensor unit 320 responsive to acoustic energy traveling in the earth co-located with a corresponding wireless sensor station. Co-located, as used herein, means disposed at a common location with one component being within a few feet of the other. Therefore, each sensor unit 320 may be coupled to a corresponding wireless station unit by a relatively short, flexible cable 322, e.g., about 1 meter in length, or coupled by integrating a sensor unit 320 with the wireless station unit 316 in a common housing 324 as shown in FIG. 3B.

The sensor unit 320 may be a multi-component sensor (not shown) that includes a three-component accelerometer sensor incorporating micro electro-mechanical systems (MEMS) technology and application-specific integrated circuits (ASIC) as found in the Vectorseis sensor module available from Input/Output, Inc., Stafford, Tex. The present disclosure, however, does not exclude the option of using velocity sensors such as a conventional geophone or using a pressure sensor such as a conventional hydrophone. Any sensor unit capable of sensing seismic energy will provide one or more advantages of the present disclosure. Furthermore, the present disclosure is useful using a single sensor unit 320 as shown, or the sensor unit 320 may include multiple sensors connected in a string.

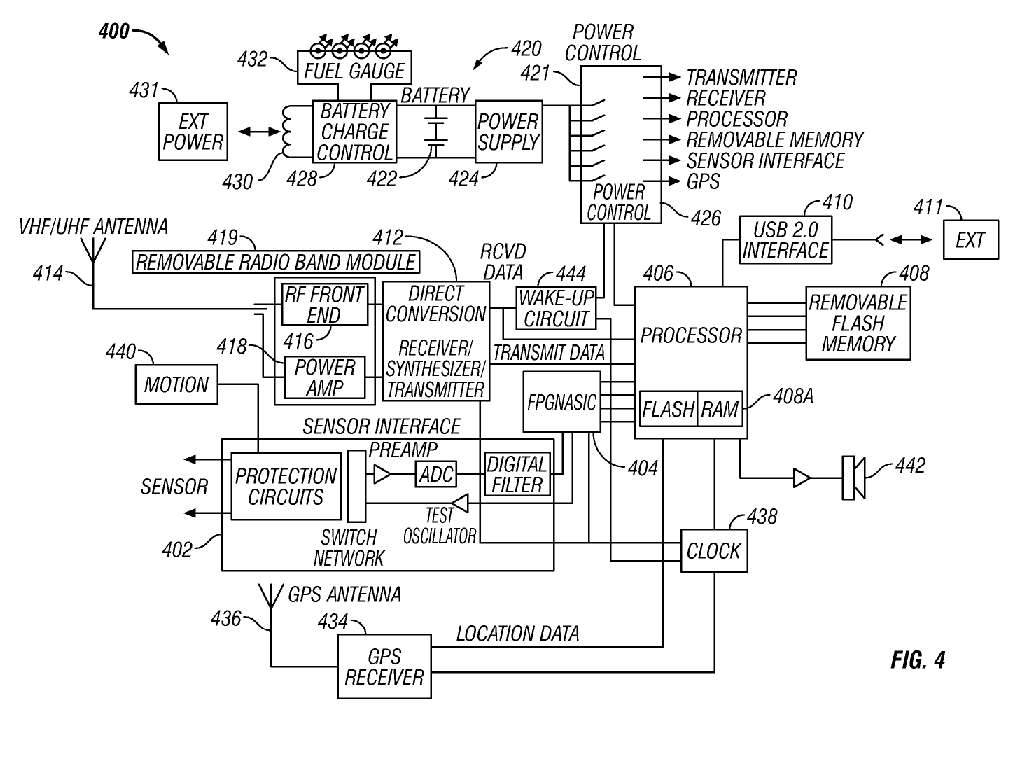

FIG. 4 is a schematic representation of a wireless station unit 400 according to the present disclosure that operates as a data recorder incorporating circuitry to interface with an analog output sensor unit (not shown). The wireless station unit 400 is an acquisition device that includes a sensor interface 402 to receive an output signal from the sensor unit. The sensor interface 402 shown includes a protection circuit, switch network, a preamplifier, a test oscillator, and ADC and digital filtering circuits to pre-process the received signal. The sensor interface 402 is controlled in part by a field programmable gate array (FPGA) and/or an ASIC controller circuit 404. An on-board local processor 406 processes the signal to create storable information indicative of the seismic energy sensed at the sensor unit. The information may be in digital form for storage in a storage device 408, also referred to herein as a memory unit. The memory unit may be removable as shown at 408 and/or dedicated 408a with a coupling 410 for providing access to the stored information and/or for transferring the stored information to an external storage unit 411. The coupling 410 might be a cable coupling as shown or the coupling might be an inductive coupling or an optical coupling. Such couplings are known and thus are not described in detail.

The memory 408, 408a may be a nonvolatile memory of sufficient capacity for storing information for later transfer or transmission. The memory might be in the form of a memory card, removable miniature hard disk drive, an Electrically-Erasable Programmable Read Only Memory (EEPROM) or the like.

A memory card, also known as a flash memory card or a storage card, is a small storage medium used to store digital information and is suitable for use in seismic prospecting. Flash memory is a type of nonvolatile memory that may be erased and reprogrammed in units of memory called blocks. It is a variation of an EEPROM, which unlike flash memory, is erased and rewritten at the byte level. Thus, updating a flash memory is typically faster than updating an EEPROM.

Interface with the central controller 202 is accomplished with a communication device such as an on-board transmitter-receiver circuit 412, and an antenna 414 selected for the desired transmitting/receiving frequency to provide direct communication with the remotely-located central controller 202. The transmitter/receiver circuit 412 shown is a direct conversion receiver/synthesizer/transmitter circuit and may alternatively be implemented as a software defined radio transceiver. Alternatively, the transmitter/receiver circuit 412 might be any suitable circuit providing transceiver functions such as a transceiver utilizing superheterodyne technology, for example. The antenna 414 may include a VHF/UHF antenna. Other circuitry might include a radio frequency (RF) front end circuit 416 and a power amplifier 418 for enhancing communication with the central controller 202. These circuits might advantageously be in the form of a removable radio band module 419 to allow operation over a broad frequency band when used with replaceable antennas. A direct conversion radio transceiver provides the advantages of operation over a broad frequency band, allows smaller overall size for the station unit 400, and reduces overall weight for field-transportable units.

Local power is provided by a power supply circuit 420 that includes an on-board rechargeable battery 422. The battery 422 might be of any suitable chemistry and might be nickel-metal hydride (NMH), a lithium-ion or lithium-polymer rechargeable battery of adequate size for the particular application. The battery provides an output to a power supply 424 to condition and regulate power to downstream circuits and the power supply output is coupled to a power control circuit 426 for distributing power to various local components. The wireless station unit 400 also includes power management circuitry 421 that shifts the station unit 400 between one or more selected levels of power use: e.g., a sleep mode wherein only the “wake” circuitry is energized to a high-active mode wherein the receiver may detect seismic energy.

The power circuit 420 further includes a charging device 428 and charger interface 430 for coupling the charging device 428 to an external power source 431. A charge indicator 432 provides an indication of amount of charge and/or charging time remaining for the power circuit 420. Such indicators are somewhat common and further description is not necessary here.

Location parameters, which include latitude, longitude, azimuth, inclination, elevation, heading (e.g., relative to north), tilt relative to gravity, etc., depth associated with a particular sensor unit 320 help to correlate data acquired during a survey. Location parameters may be in reference to a congenital reference, e.g., magnetic north, or an arbitrary reference frame for a particular survey area. The location parameters may utilize Cartesian-type coordinates, polar coordinate or another other suitable coordinate system. In the case of the FIG. 1 cable system, the location parameters may relate to the sensor 102 and/or field box 103. In the case of the FIG. 2 wireless system, the location parameters may relate to a particular wireless sensor station 208 and/or a sensor unit 320 and may help correlate data acquired during a survey. For ease of explanation, reference will be made herein to the system shown in FIGS. 2-4.

The location parameters determined prior to a survey using a selected sensor location and nominal sensor orientation and the parameters may be adjusted in-field. The location parameters are stored in a memory 303, 408 either in the central controller or in the station unit 400. In one embodiment, the wireless sensor station includes a global positioning system (G PS) receiver 434 and associated antenna 436. The GPS receiver in this embodiment is shown coupled to the processor 406 and to a clock circuit 438 to provide location parameters such as position and location data for correlating seismic information and for synchronizing data acquisition. Alternatively, location parameters may be transmitted to and stored in the central controller and synchronization may be accomplished by sending signals over the VHF/UHF radio link independent of the GPS. Therefore, the on-board GPS may be considered an optional feature of the disclosure. In For example, referring to FIG. 2, the mobile unit 502i includes a human operator who may utilize a navigation tool 504i that determines and supplies location information. The location parameters associated with sensor orientation may be determined by on-board accelerometers, magnetic sensors, navigation sensors and/or by external devices.

In one embodiment, a wake up circuit 444 allows the wireless station unit to control power consumption from the battery throughout different operating modes. The wake up circuit 444 may be triggered from a number of specified sources; the radio receiver 412, the clock 438, a motion sensor or environmental condition sensor (not shown). In a low power mode, for example, power is applied only to the radio receiver 412 and the wake up circuit 444. If a specific wake up command is transmitted over the radio and decoded by the wake up circuit, other circuits such as the processor 406 will be enabled and come on-line to support further processing of commands and signals received from the sensor unit. Alternatively the wake up circuit could energize the radio receiver 412 at predetermined time intervals as measured by signals received from the clock 438. At these intervals the radio receiver would be enabled briefly for receiving commands, and if none are received within the enabled time period, the receiver 412 will power down, either autonomously or by command from the wake up circuit.

In one embodiment, the wireless station unit 400 further includes a motion sensor 440 to detect unwanted movement of the station unit or to detect around the station unit, in which a proximity sensor might be used. Any unwanted movement will be detected by the motion sensor, and a motion sensor output is coupled to the unit by a dedicated interface circuit, or the output may be integrated into the sensor interface. The motion sensor output is processed using the on-board processor 406 and the processed output is transmitted via the on-board transmitter/receiver circuit 412 to the central controller to alert the operator of the unwanted movement. The GPS receiver output may be processed along with the motion sensor output.

In one embodiment, the function of motion sensing is accomplished with the same sensor unit 208 as is performing the seismic energy sensing function. In the embodiment described above and referring to FIG. 3B having the sensor unit integrated into the wireless station unit, the seismic sensor output will necessarily include components associated with the desired sensed seismic activity as well as sensed components associated with unwanted movement. The output is processed in conjunction with the output signal from the GPS receiver to indicate unwanted station movement. Thus, an output signal transmitted to the central controller 202 might include information relating to unwanted movement as well as seismic information, state of health information or other information relating to a particular wireless station unit 316 and/or sensor unit 320.

Referring to FIGS. 2-4, as discussed above, the system 200 includes a central controller 202 remotely located from a plurality of station units 208. Each station unit 208 includes a sensor unit 320 remotely located from the central controller 202. Each sensor unit 320 is coupled to the earth for sensing seismic energy in the earth, which might be natural seismic energy or energy produced from a seismic source 206. The sensor unit 320 provides a signal indicative of the sensed seismic energy and a recorder device 316 co-located with the sensor unit receives the signal stores information indicative of the received signal in a memory unit 408 disposed in the recorder device 316. A communication device 412 is co-located with the sensor unit and the recorder device for providing direct two-way wireless communication with the central controller.

In some embodiments, the station units 208 utilize conventional rechargeable batteries that provide about seventy to eighty hours of operating life for each unit. Since a given deployment may last over fifteen days, “unmanaged” operation of the sensor stations 208 may impact the efficiency or effectiveness of a seismic survey campaign. For example, one aspect of not actively managing the operating states of the sensor stations 208 is inefficient power consumption by the sensor stations 208. That is, unnecessarily operating the sensor stations 208 in operating states that require high power may deplete the batteries within seven or so days. Unmanaged operations may include, for instance, continuously operating the sensor stations 208 at a state where all on-board circuitry and components are in a “ready” condition. This may cause the sensor stations 208 to be continuously draining the batteries for ten or more hours. Recharging the batteries may be labor-intensive and could delay or otherwise interfere with the data acquisition operations. Replacing batteries may also be labor intensive and additionally require a stock of replacement batteries, which also may be costly. Additionally, the station units 208 may have limited on-board memory capacity. Operating the sensor stations 208 continually in a recording operating state may cause the sensor stations 208 to record non-information bearing data along with the useful seismic data, which may cause on-board memory devices to prematurely reach capacity. Moreover, time, bandwidth and resources may be unnecessarily consumed when retrieving the data stored in the memory devices because the non-information bearing data must be retrieved along with the seismic data.

In aspects, the present disclosure includes operating state management methods and systems that optimize one or more aspects of seismic data acquisition, e.g., power consumption by above-described seismic data acquisition systems, data storage capacity, optimize transmission bandwidth usage by seismic devices, increase operating life of seismic devices, etc. The operating state management may be applied to any seismic device, including sensors, sensor stations, receivers, transmitters, power supplies, control units, sources, navigation tools, repeaters, etc.

One exemplary operating state management method optimizes power consumption by automating one or more aspects of the interaction between the Central Station Computer (CSC) 500, one or more mobile units 502i, and the seismic spread 210. In one embodiment, the CSC 500 transmits data that enables one or more sensor stations 208 in the spread 210 to adjust operating states in a manner consistent with the firing of the sources 206i. The data may be transmitted to a specific sensor station or group of sensor stations or transmitted in a “broadcast” fashion to the spread 210. In response to the transmitted data, the circuitry of the sensor stations 208 places the sensors 320 and other equipment into the appropriate operating state, each of which may have a corresponding level of power use: e.g., a sleep mode, an intermediate power state, a high-active mode, etc. For example, the sensor stations 208 may utilize a computer-readable medium that is accessible to a processor for executing instructions contained in a computer program embedded on the computer-readable medium. The computer program may include a set of instructions to receive a signal transmitted by a controller positioned in a geographical area of interest; a set of instructions to process the signal to determine an operating state associated with a seismic device configured to measure and record seismic data; and a set of instruction to initiate a transition to the determined operating state. The medium may be associated with one or more sensor stations or any other seismic device. Also, the CSC 500 may utilize a computer-readable medium that is accessible to a processor for executing instructions contained in a computer program embedded on the computer-readable medium. The computer program may include a set of instructions to determine an operating state for at least one seismic device positioned in a geographical area of interest; a set of instructions to encode a signal with data relating to the operating state; and a set of instructions to transmit the signal to at least one seismic device positioned in a geographical area of interest.

An exemplary CSC 500 includes one or more processors programmed with instructions that controls firing of sources 206i in a predetermined sequence or progression. For instance, the CSC 500 controls firing initiation, the sequence of firing and the time interval between firings. In one mode, a plurality of mobile units 502i each navigates to a separate source 206i. Each mobile unit 502i transmits a signal to the CSC 500 upon locating a source 206i. As discussed previously, the mobile unit 502i includes a source controller 506i that controls the firing of the sources 206i. In an exemplary operating mode, the source controller 506i determines the location (e.g., x-y-z coordinates) of the source 206i from a GPS Device (not shown) and transmits the coordinates to CSC 500. In response, the CSC 500 transmits status information to the source controller 502i, which may be presented visually or otherwise to the human operator. The status information may include the relative position of the mobile unit 502i in a queue of mobile units that have reported as ready to fire and expected time until firing commences. By “reporting,” it is generally meant transmitting a data encoded signal, which may be a voice signal or a machine generated signal, that may be processed by the CSC 500. When ready, the CSC 500 transmits an “arm” signal to instruct the mobile unit 502i to prepare the source for firing. Upon receiving a “fire” signal transmitted by the CSC 500, the mobile unit 502i initiates the necessary actions to fire the source 206i. Optionally, a mobile unit 502i may simply maintain the source 206i in the “armed” position so that when the CSC 500 transmits the “fire” signal when it is ready, the source controller 504i immediately fires the source 206i.

The exchange of data between the mobile units 502i and the CSC 500 enables the CSC 500 to manage the queue of mobile units 502i that report as having found a source 206i. In accordance with programmed instructions, CSC 500 determines a progression of firing of the sources 206i, and transmits appropriate instructions/data to the reporting mobile units 502i and the receiver spread 210.

In one operating state management scheme, the sensor stations 208 making up the spread 210 are divided into defined sets of sensor stations. For convenience, a set of sensor stations 208 will be generally referred to as a template. Each template is associated with one or more sources 206i. While each template may include different sensor stations 208, such is not necessary the case. That is, some templates may share sensor stations 208. Referring to FIG. 2, there are shown three illustrative templates 510a, 510b, 510c. Templates 510a and 510b are composed of distinct sensor stations 208 whereas template 510c shares some sensor stations 208 with templates 510a and 510b. Additionally, a “super-template” 510d or composite template may be formed through one or more of a union of individual templates, portions of individual templates, and/or seismic stations 208 not belonging to a particular individual template. A template may be based on geometric shapes (e.g., circles, fans, squares), mathematical models that predict which sensor stations 208 will most efficiently detect seismic energy from a given source 206i, relative proximity or any other suitable methodology. Of course, in practical applications, a template may include tens or hundreds of sensor stations 208. In an exemplary simple arrangement, all the sensor stations 208 in a spread 210 are grouped together in a single template that is associated with every source 206i that is used. In an exemplary complex arrangement, a separate template is formed for each source 206i. The utility of the templates will be discussed below in connection with exemplary deployment modes.

In one illustrative deployment mode, the operating states of the sensor stations in a seismic spread are coordinated with the status and number of sources that are prepared to “shoot” or fire. For instance, when a preset minimum number of sources report as ready to fire, the sensor units transition from the sleep mode to a partial or full active mode to detect and record seismic energy. When the number of sources reporting as ready to fire drops below a preset minimum, the CSC signals the sensor units to transition from a partial or full active mode to the sleep mode. For convenience, these two values will be referred to as a “wakeup” threshold value and a “sleep” threshold value, respectively.

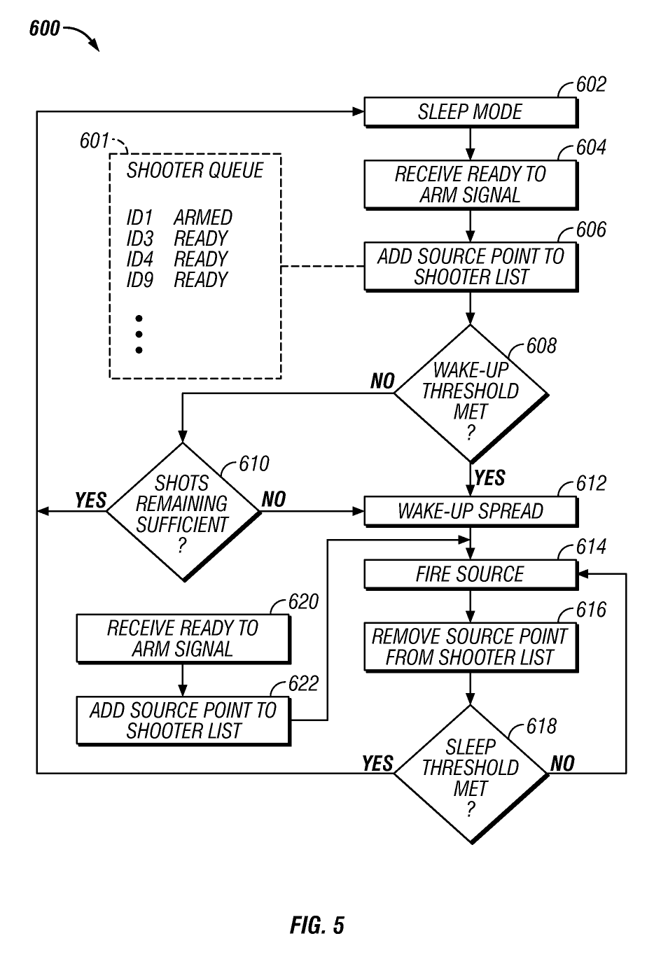

Referring now to FIG. 5, there is shown a flow chart 600 for control over a seismic spread, such as spread 210, wherein a single template includes all of the sensor stations in a spread and there are a total of five sources to be shot. The wake up threshold value is set to three and the sleep threshold value is set to zero. In the discussion below, the reference numerals for the individual components have been omitted for ease of narration.

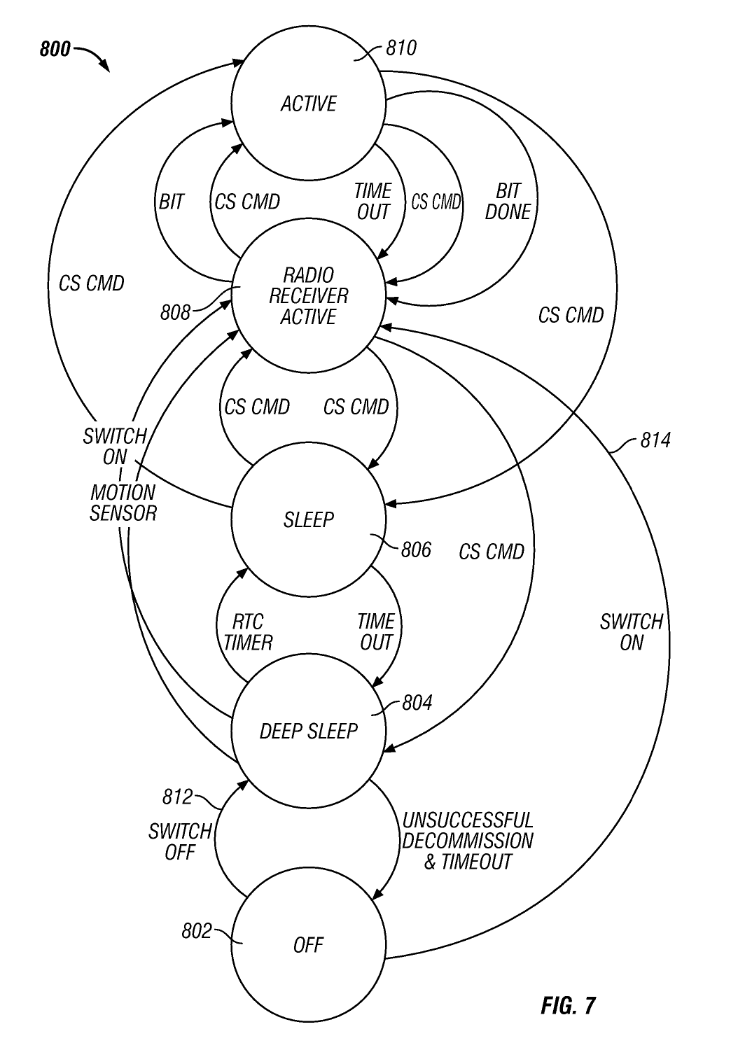

At step 602, initially, the entire spread is in a sleep mode. At step 604, a first mobile unit transmits a “Ready to Arm” message upon locating a first source. A “ready to arm” message is generally a message indicating that a source is in a condition to be shot or may be immediately put in such a condition. At step 606, the CSC adds the mobile unit to a “Ready” list, an electronic list or queue which tracks the status of mobile units that have reported to the CSC. At step 608, the CSC determines that the sensor stations should remain in a sleep mode because only one mobile unit has reported as ready whereas the wake-up threshold value is three. At step 610, the SCS confirms that sufficient sources are available to meet the threshold wake-up value and continues the sleep mode. The shots remaining may be tallied in a separate list, e.g., a “shot management” list and the list may be referenced by the SCS. Steps 604, 606, 608 and 610 are repeated when a second mobile unit sends a “Ready to Arm” message from a second source. Again, the CSC does not wake up the sensor spread because only two mobile units have reported as ready but the wake-up threshold value is three. Steps 604 and 606 are also repeated when a third mobile unit sends a “Ready to Arm” message from a third source. The CSC adds the third mobile unit to the “Ready” list. However, at step 608, because three mobile units have reported as ready and the wake-up threshold value is three, the CSC proceeds to step 612 by transmitting a signal indicating that shots will begin. In response to the signal, the sensors stations in the template, which is the entire spread, transitions from the sleep mode to one of several elevated power usage modes, which are discussed in further detail with reference to FIG. 7. At step 614, the first source is fired and the CSC removes the first mobile unit from the “Ready” list 601 at step 616. At step 618, the CSC checks the sleep threshold value and determines that global sleep is not required because there are two mobile units in the “Ready” list, which is greater than the sleep threshold value of zero. Step 614 is repeated to fire the second source and the CSC removes the second mobile unit from the “Ready” list 601 at step 616. At step 620, a fourth mobile unit sends “Ready to Arm” message from a fourth source and the CSC adds the fourth mobile unit to the “Ready” list at step 622. Thereafter, at steps 614 and 616 the third source is fired and the CSC removes the third mobile unit from the “Ready” list. At step 618, the CSC checks the sleep threshold value and determines that global sleep is not required because there is one mobile unit in the “Ready” list, which is greater than the sleep threshold value of zero. Steps 614 and 616 are repeated for the fourth source. At step 618, the CSC checks the sleep threshold value and determines that sleep mode is required because the sleep threshold value of zero equals the number of mobile units in the “Ready” list. The CSC transmits a signal indicating that shots will cease. In response, the sensor stations transition into the sleep mode at step 602. At steps 604 and 606, a fifth mobile is added to the “Ready” list unit after sending a “Ready To Arm” message from a fifth source. At step 608, the CSC initially determines that wakeup is not required because only one mobile unit is reporting as ready. However, at step 610, the CSC determines that only one source remains to be fired. Thus, the CSC proceeds to step 612 to cause the entire spread to transition to a full active power mode. Finally, the fifth source is fired and the CSC removes the fifth mobile unit from the “Ready” list at steps 614 and 616. At step 618, the CSC finds that there are zero mobile units ready to fire, which equals both the sleep threshold value and the number of remaining shots in the “shot management” list. Thus, The CSC transmits a signal indicating that shots will cease. In response, the sensor stations transition into the sleep mode.

In another illustrative deployment mode, the spread is grouped into multiple templates, each of which is associated with a separate source. In the example below, there are eight shots, the wake-up threshold is set to four and the sleep threshold is set to two.

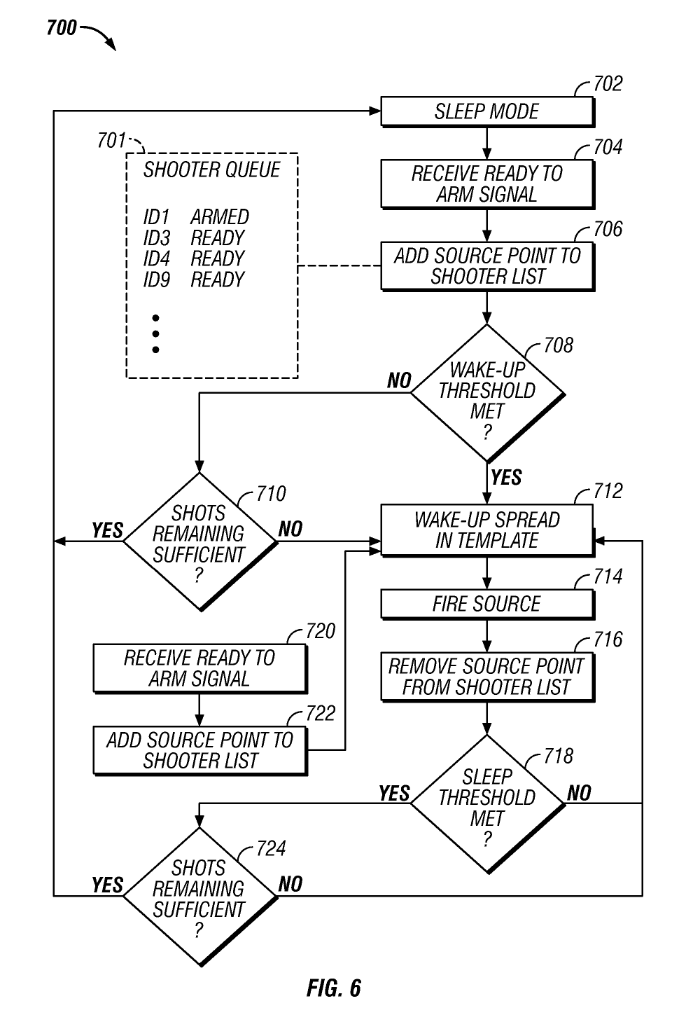

Referring now to FIG. 6, there is shown a flow chart 700, wherein initially, at step 702, the entire spread is in a dormant operating state or sleep mode. At step 704, upon receiving a “Ready to Arm” message from a first mobile unit that has located a first source, the CSC adds the mobile unit to a “Ready” list at 706. At step 708, the CSC determines that a change in operating states or “wake-up” is not needed because only one mobile unit has reported as ready but the wake-up threshold value is four. At step 710, the CSC determines that there are sufficient mobile units that are available to meet the wake-up threshold value and continues the sleep mode. Steps 704-710 are repeated when second and third mobile units send “Ready to Arm” messages from a second and third source, respectively. Steps 704-706 are repeated for a fourth mobile unit that sends a “Ready to Arm” message from a fourth source. However, at step 708, because four mobile units have reported as ready and the wake-up threshold value is four, the CSC determines which of the templates correspond with the first through fourth sources and forms a composite or “super” template. Thus, the CSC proceeds to step 712 wherein the CSC transmits a signal indicating that sensor stations belonging to the super template should transition to a full active mode to record seismic data. In response to the signal, the sensors stations in the super template transition from the sleep mode to an active power mode. When the sensor stations in the super template have powered up, at step 714, the first source is fired and the CSC removes the first mobile unit from the “Ready” list at step 716. At step 718, the CSC checks the sleep threshold value and determines that global sleep is not required, because there are three mobile units in the “Ready” list, which is greater than the sleep threshold value of two. At step 720, a fifth mobile unit sends a “Ready to Arm” message from a fifth source and the CSC adds the fifth mobile unit to the “Ready” list at step 722. In response, at step 712, the CSC transmits a signal indicating that sensor stations belonging to the template associated with the fifth source should transition to a full active mode. Thereafter, at step 714, the second source is fired and the CSC removes the second mobile unit from the “Ready” list at 716. At step 718, the CSC checks the sleep threshold value and determines that global sleep is not required, because there are three mobile units in the “Ready” list, which is greater than the sleep threshold value of two. Steps 714-716 are repeated for the third source. At step 718, when the CSC checks the sleep threshold value, the CSC determines that sleep mode is required because the sleep threshold value of two equals the number of mobile units in the “Ready” list. After confirming at step 724 that sufficient shots remain to enter a sleep mode, the CSC transmits a signal indicating that shots will cease. In response, all the sensor stations transition into the sleep mode at step 702. Steps 704-706 are repeated when a sixth mobile unit sending a “Ready To Arm” message from a sixth source. At steps 708-710, the CSC does not wake up the sensor spread because less than four mobile units have reported as ready and sufficient sources are available to maintain the sleep mode.

Steps 704-706 are also repeated for a seventh mobile unit that sends a “Ready to Arm” message from a seventh source. At step 708, because four mobile units have reported as ready and the wake-up threshold value is four, the CSC determines which of the templates correspond with the fourth through seventh sources and forms a composite or “super” template. Thereafter, at step 712, the CSC transmits a signal indicating that sensor stations belonging to the super template should transition to a full active mode. In response to the signal, the sensors stations in the super template transition from the sleep mode to an active power mode. At steps 714-716, the fourth source is fired and removed from the “Ready” list. At step 718, The CSC checks the sleep threshold value and determines that global sleep is not required, because there are three mobile units in the “Ready” list, which is greater than the sleep threshold value of two. At step 720-722, an eighth mobile unit sends a “Ready To Arm” message from an eighth source and is added to the “Ready” list. At step 712, the CSC transmits a signal indicating that sensor stations belonging to the template associated with the eighth source should transition to a full active mode. At steps 714-716, the fifth source is fired and removed from the “Ready” list. At step 718, the CSC checks the sleep threshold value and determines that global sleep is not required because there are three mobile units in the “Ready” list, which is greater than the sleep threshold value of two. At steps 714-716, the sixth source is fired and removed from the “Ready” list.

At step 718, the CSC initially determines that a sleep mode is required because only two mobile units are reporting as ready. However, at step 724, because the CSC determines that only two sources remain to be fired as shown in the “shot management” list. Thus, the CSC maintains the sensor stations in a full active power mode. Thereafter, at steps 714-716, the seventh and eighth sources are fired in succession and removed from the “Ready” list. At step 724, the CSC finds that there are zero mobile units ready to fire, which equals both the sleep threshold value and the number of remaining shots in the “shot management” list. Thus, The CSC transmits a signal indicating that shots will cease. In response, all sensor stations in a full active power mode transition into the sleep mode at step 702.

It should be appreciated that a number of schemes or protocols may be used to control the firing of the sources 206i and to appropriately shift or adjust the operating states of the sensor stations 208. As described above, the CSC 500 may be programmed to initiate firing of the sources 206i only after the queue includes a preset minimum of sources 206i that report as ready to fire and the firing order may be based on the order in which the sources 206i reported to the CSC 500. The time interval between the firings may be selected to ensure that the sensor stations have adequate time to receive and record the seismic data. Moreover, the list or queue may be dynamic in that sources 206i may be added to the queue as the prior members in the queue are fired. Still further, the protocol for setting the sequence in which the sources 206i are fired may include layers of complexity. For example, a predictive model may be used to optimize the firing order or sequence. The predictive model may rearrange the firing order to improve data quality, reduce operating time, etc. For example, a predictive model may use a Geographic Information System (GIS) database, data from previous shoots, well data, historical data, etc. Furthermore, while the above described methods utilize human intervention to control the firing of the sources 206i, in certain applications of the present disclosure, a programmed controller may exert full command and control over a specified activity with no human intervention.

In another protocol, the CSC 500 may use the encoded data to instruct selected sensor stations to transition to a desired operating state based on an order of the queue. For instance, based on the status of seismic sources 206i reporting as ready to fire, the CSC 500 may determine that sensor stations identified in one or more templates should be in an operating state for listening and recording data. Thus, the CSC 500 may instruct the sensor stations identified in those templates to transition to listen and record operating state. In one transmission mode, the instruction is sent only to identified sensor stations within the templates. In another transmission mode, the instructions may be broadcast to the spread 210 but include further information that enable each sensor station to determine whether that sensor station is within the relevant templates. Exemplary information for making that determination may be position coordinates, sensor station identification numbers, time, operating state, etc.

In another protocol, the CSC 500 may transmit a signal with encoded data that may include instructions for certain sensor stations to transition to a first operating state and include further data and/or instructions that enable each sensor station to self-select another operating state. For instance, based on the status of seismic sources 206i reporting as ready to file, the CSC 500 may determine that sensor stations in template 510d should be in an operating state to initiate the recording of data. In the same or different signal, the CSC 500 may transmit data to the sensor stations in template 510d that enable each sensor station to determine whether to actually start recording data. For instance, the CSC 500 may determine that several sources are ready to shoot in sequence in template 510d and instruct the sensor stations in that template to move to a ready to record operating state. The same signal or a separate signal may provide information such as timing and/or source position information that enable individual sensor stations to determine whether to begin recording or wait until a specific source is ready to shoot before moving to a recording state. That is, the sensor stations in template 510b may start recording because due to their proximity with a source that is selected to fire, but the sensor stations in template 510a may delay moving to a record data state because of insufficient proximity to the source that is selected to fire. The sensor stations in template 510a may, however, rapidly transition to a recording state once the source or sources proximate to those stations are ready to fire. It should be appreciated that usage of sensor station memory capacity may be optimized by this methodology. In another aspect, it should be appreciated that the selection of the appropriate operating state has been performed cooperatively by the CSC 500 and the individual sensor stations.

Referring now to FIG. 2, it should be appreciated that the any of the seismic devices in the seismic spread 210, such as the sensor stations 208, may be programmed to “self-select” an operating state during a given seismic data acquisition activity. In the above described methods, the CSC 500 periodically transmits data to the seismic spread 210. This data, in one arrangement, is not specific to a particular sensor station, source, etc. Rather, as previously described, the data is broadcast to a portion of the seismic spread or the entire seismic spread. Advantageously, each seismic device may be aware of its position relative to a reference point. Thus, by encoding data with the reference point, each seismic device independently selects an appropriate response to the broadcast signal.

For example, a GPS device may enable a sensor station to be aware of its position relative to the position of a given source, or “shot point.” A broadcast signal may include the identity of one or more sources, or shot points. Each sensor stations upon receiving the broadcast signal, individually determines whether or not to adjust its operating state based its position relative to the one or more sources. Moreover, the broadcast signal may include a selection parameter that the sensor stations may use to determine whether a change in operating states is needed. For example, the broadcast signal may define a geometrical shape, e.g., a fan shape, circle, etc., within which a sensor station must lie in order to move to an operating state wherein seismic energy can be sensed and seismic data recorded, which may require a full active power state. Thus, in one aspect, the disclosure provides a method and devices for automatically and intelligently transitioning power consuming devices in seismic spreads to the appropriate operating state, which may then optimize power usage.

Referring now to FIG. 7, there is shown an exemplary diagram 800 of the various operating states for a given sensor station and their corresponding power states. The power states in order of power usage include: off 802, deep sleep 804, sleep 806, radio receiver active 808 and active 810. At the off state 802, there is minimal, if any, power usage. Each subsequent operating state increases the activity of the power station by energizing additional hardware. At deep sleep 804, only the wake-up circuitry is energized, which allows the sensor station to respond to transmitted signals or instructions. At sleep 806, the radio receiver is energized and processing hardware may be booted on. At radio receiver active 808, the sensor station may fully energize a transceiver and processors. At active 810, all on-board circuitry and hardware, include the sensors, processors, RAM, GPS may be brought to a full ready position. It should be appreciated that the progression may be either a gradual stepwise progression as shown by arrow 812 or a jumped progression as shown by arrow 814. Thus, it should be appreciated that the sensor station circuitry may select an operating state for the sensor station that is appropriate given the operating status of the seismic spread. Furthermore, the circuitry may efficiently shift between any of the several operating states as needed to adapt to changing operating conditions.

While the particular disclosure as herein shown and disclosed in detail is fully capable of obtaining the objects and providing the advantages hereinbefore stated, it is to be understood that this disclosure is merely illustrative of the presently described embodiments of the disclosure and that no limitations are intended other than as described in the appended claims.

What is claimed is:

1. A method for conducting seismic data acquisition, comprising:
(a) configuring a plurality of seismic devices to select an operating state in response to a signal;
(b) deploying the plurality of seismic devices in a geographical area of interest;
(b) transmitting at least one signal to the plurality of seismic devices; and
(c) measuring seismic data using at least one of the seismic devices.

2. The method of claim 1 wherein the operating state is associated with one or more of: (i) reporting a status, (ii) a diagnostic, (iii) data collection, (iv) processing data, (v) data transmission, (vi) reporting an activity, (vii) receiving data, (viii) sleep mode; and (iv) data recording.

3. The method of claim 1 further comprising encoding the at least one signal with an instruction to transition to a specified operating state.

4. The method of claim 1 further comprising encoding the at least one signal with data relating to a selected operational parameter of a survey; and processing the at least one signal in the seismic devices to select the operating state.

5. The method of claim 1 further comprising deploying a plurality of seismic sources in the geographical area of interest; and forming a queue with a processor, the queue including at least one seismic source from a plurality of seismic sources.

6. The method of claim 5 wherein the queue includes a plurality of seismic sources and the controller; and further comprising determining an order for activating the plurality of sources.

7. The method of claim 5 wherein the controller forms the queue using preprogrammed instructions.

8. The method of claim 7 wherein the preprogrammed instructions include at least one of: (i) a minimum number of seismic sources for the queue, (ii) a parameter relating to a seismic source location, (iii) a parameter relating to a seismic source condition, (iv) a predictive model, (v) a power conservation parameter; (vi) a selected number for sensor stations in the full operating state, (vii) a parameter relating to a sensor station location, (viii) a parameter relating to a sensor station condition; (ix) a parameter identifying a seismic source; and (x) a parameter identifying a sensor station.

9. The method of claim 1 further comprising providing at least one of the plurality of seismic devices with a memory having a location parameter associated with the at least one seismic device.

10. The method of claim 1 further comprising providing a location parameter to at least one of the plurality of seismic devices.

11. The method of claim 1 wherein the at least one signal includes a parameter relating to at least one seismic source imparting seismic energy into a subterranean formation.

12. A seismic data acquisition system, comprising:
(a) a controller; and
(b) a plurality of seismic devices in communication with the controller, each of the plurality of seismic devices selecting an operating state in response to a signal transmitted by the controller.

13. The system of claim 12 wherein the operating state is associated with one or more of: (i) reporting a status, (ii) a diagnostic, (iii) data collection, (iv) processing data, (v) data transmission, (vi) reporting an activity, (vii) receiving data, (viii) sleep mode, and (iv) data recording.

14. The system of claim 12 wherein the signal includes an instruction to transition to a specified operating state.

15. The system of claim 12 wherein the signal includes data relating to a selected operational parameter of a survey; and wherein the seismic devices are configured to process the signal to select the operating state.

16. The system of claim 12 further comprising a plurality of seismic sources, and wherein the controller forms a queue including at least one seismic source from the plurality of seismic sources.

17. The system of claim 16 wherein the queue includes a plurality of seismic sources and the controller determines an order for activating the plurality of sources.

18. The system of claim 16 wherein the controller forms the queue using preprogrammed instructions.

19. The system of claim 18 wherein the preprogrammed instructions include at least one of: (i) a minimum number of seismic sources for the queue, (ii) a parameter relating to a seismic source location, (iii) a parameter relating to a seismic source condition, (iv) a predictive model, (v) a power conservation parameter; (vi) a selected number for sensor stations in the full operating state, (vii) a parameter relating to a sensor station location, (viii) a parameter relating to a sensor station condition; (ix) a parameter identifying a seismic source; and (x) a parameter identifying a sensor station.

20. The system of claim 1 wherein at least one of the plurality of seismic devices includes a memory having a location parameter associated with the at least one seismic device.

21. The system of claim 12 further comprising a location sensor providing a location parameter to at least one of the plurality of seismic devices.

22. The system of claim 12 further comprising a receiver associated with the sensor station configured to receive a broadcast signal.

23. The system of claim 12 wherein the transmitted signal includes a parameter relating to at least one seismic source imparting seismic energy into a subterranean formation.

24. A computer-readable medium that is accessible to a processor for executing instructions contained in a computer program embedded on the computer-readable medium, wherein the computer program comprises:
a set of instructions to receive a signal transmitted by a controller positioned in a geographical area of interest;
a set of instructions to process the signal to determine an operating state associated with a seismic device configured to measure and record seismic data; and
a set of instruction to initiate a transition to the determined operating state.

25. A computer-readable medium that is accessible to a processor for executing instructions contained in a computer program embedded on the computer-readable medium, wherein the computer program comprises:
a set of instructions to determine an operating state for at least one seismic device positioned in a geographical area of interest; and
a set of instructions to encode a signal with data relating to the operating state; and
a set of instructions to transmit the signal to at least one seismic device positioned in a geographical area of interest.
